(19) United States
(12) Patent Application Publication
(10) Pub. No.: US 2024/0218697 A1
(43) Pub. Date: Jul. 4, 2024

(54) DOOR LOCKING DEVICE

(71) Applicant: Adrian STAJKOW, Warszawa (PL)

(72) Inventor: Adrian STAJKOW, Warszawa (PL)

(21) Appl. No.: 18/198,956

(22) Filed: May 18, 2023

(30) Foreign Application Priority Data
Dec. 29, 2022 (PL) P.443338

(51) Int. Cl. E05B 13/00; E05B 19/20

(52) U.S. Cl. CPC E05B 13/005; E05B 19/205

(57) ABSTRACT

A device for locking movable partitions that restricts the access to confined areas, having a key, lock and a handle, provided with a latching/release mechanism and a bolting mechanism, characterised in that the key (1) has a flat shape and is provided with a set of movable, concentrically-arranged, closed rings in the form of: an outer ring (2), a central ring (3) and an inner ring (4) integrated with a central disc (5), wherein each one of the rings (2, 3, 4) is provided with at least three, semi-spherically shaped decoders (6), while the central disc (5) has a centrally-located stabilising through hole (7) that has at least two angled corners (8), wherein lock (9) consists of a movable press (10) and a rotary positioner (12) connected with the bolting mechanism (11), wherein the movable press (10) is provided with a centrally-located wedge element (13), the base (14) of which has a shape that corresponds to the shape of the stabilising hole (7) of key (1), while the rotary positioner (12) is provided with a centrally-located wedge channel (15) that enables the installation of wedge element (13) of movable press (10) therein, simultaneously the flat surface (16) of the rotary positioner (12) has elastic studs (17), wherein between the movable press (10) and the rotary positioner (12) there is a pressure gap (18) that acts as the termination of input tunnel (20), wherein the input tunnel (19) and the output tunnel (20) act as keyways for the movement of key (1), wherein the input tunnel (19) begins with feeder (22), while the output tunnel (20) ends with receiver (23), wherein the feeder (22) and the receiver (23) constitute flat openings installed on door (21) that enable the insertion and removal, respectively, of key (1), wherein the minimum width (W18) of pressure gap (18) represents at least the width (W1) of key (1).

The present invention relates to a door locking device that restricts access to confined areas and can be used especially in entry doors to buildings, residential apartments and hotel rooms, as well as in garage doors, safes, lockers of all kinds, etc.

Known in accordance with the present art are keys to locks and locking systems, in which keys are equipped with a substantial number of elements that improve the safety of the lock and allow a specific number of locking code combinations. They are usually provided with three latch guides, arranged on the flat surfaces of the key in a manner that ensures the most effective use of the available space.

For example, U.S. Pat. No. 5,438,857 discloses a key and cylinder provided with an additional element that improves locking safety, in the form of an interlock that prevents the insertion of an incorrect key. This was achieved by providing the key with an inclined surface and the cylinder with a latch, located at the opening, that prevents the insertion of a key without an appropriately inclined surface. The inclined surface is arranged at the tip of the key and forms a wedge, with its blade facing towards the tip of the key, and appropriately cuts through the central plane that divides the key, so that the latch is moved away when the key is inserted into its corresponding cylinder. In this way, the latch prevents the insertion of a key that does not have an adequately inclined surface.

Known to the prior art are safety locks for residential doors and others, which include a housing with a keyhole for inserting a key, with at least one deadbolt present inside the housing and protruding on one side thereof, a plate connected with the deadbolt that has a set of prongs that engage with the key in order to control the movement of the deadbolt.

For example, in accordance with the prior art, Polish invention No. P.389018 discloses a mortise, self-locking door lock, characterised in that the guide of the deadbolt has an notch, preferably at the top edge, and is provided with an adjacent bolting plate. The latching plate has a latching hitch in its upper part and a retaining ridge in its lower part. The lock is provided with a latching lever, located behind the guide on the lower housing. Between the guide and the clamping follower there is a lever-shaped fork, which moves back and forth at the turn of the handle and activates the guide and the latch during rotation. The latching lever has a catch and a latching prong.

Lock and key combinations are disclosed in German patent description No. DE A3424307, which describes a cylinder lock with a rotary plug that is provided with a keyway. A key can be inserted into the keyway in order to push or rotate the interlocking elements. The key has a flat blade and a coding element that can be pushed, turned or moved upwards in relation to one of the flat sides of the blade. Inside the keyway, the coding element is pushed into a widening or a recess by restoring forces, by the shape of the key, keyway or by magnetic forces. The movable mechanism or the magnetic locking element is arranged in the widening or recess. The coding element is arranged on the key, in the direction perpendicular to the key overlays.

Locking systems consisting of a single key are also known to the prior art. For example, known to the prior art is Spanish application No. ES 2135330 which describes a lock, key and a codifier. This solution includes a mechanism, as well as electronic systems. The invention enables the generation of a single key that is authorised to open multiple locks.

Taiwanese application No. TW 201247982, meanwhile, discloses a method of using a single key to open multiple locks and their structure, which includes different pin lock plug types with the same keyway. Pin lock plugs are formed with at least one row of spring-actuated pins and positioning pins for the blocking of the lock plug and the lock bracket. Both the number and the displacement of the positioning pins in the lock plugs may vary. The key is provided with a pattern of variable positioning pin slots, which enables the use of one key to open multiple locks.

In the vast majority of known systems, the key, as the lock opening and locking element, has a suitably formed cam, which positions the lock latches in a position that enables the rotation of the cylinder and the movement of the locking bolt.

The existing systems have a disadvantage in that the access to the lock via the keyhole is easy, and therefore it is possible to open it using a suitable tool that can successively position the individual latches in suitable positions. Easily accessible locks are also vulnerable to being breached by drilling or by forcing.

Another disadvantage of the existing locking systems is the absence of a suitable code protection class, e.g. due to the use of a lower number of possible key notches on the latch and due to manufacturing imprecisions. In such cases, it may be even possible to open the lock with a different key, or using a similar code combination.

Additionally, the vast majority of known systems require the possession of one key that corresponds to a specific lock, one which locks and opens only the specific door. This consequently generates certain problems, e.g. in the event of the key being lost or stolen.

The purpose of the invention is to develop a fully mechanical device that is effectively burglar-proof, wherein one key can be used to open and lock multiple locks.

The present invention relates to a device for locking doors that restricts access to confined areas, having a key, lock and a handle, provided with a latching/release mechanism and a bolting mechanism, characterised in that the key has a flat shape and is provided with a set of movable, concentrically-arranged, closed rings in the form of: an outer ring, a central ring and an inner ring integrated with a central disc, wherein each one of the rings is provided with at least three, semi-spherically shaped decoders, while the central disc has a centrally-located centering through hole that has at least two angled corners, wherein the lock consists of a movable press and a rotary positioner connected with the bolting mechanism, wherein the movable press is provided with a centrally-located wedge element, the base of which has a shape that corresponds to the shape of the stabilising hole of key, while the rotary positioner is provided with a centrally-located wedge channel that enables the installation of a wedge element of a movable press therein, simultaneously the flat surface of the rotary positioner has elastic studs and suppressing rods, wherein between the movable press and the rotary positioner there is a pressure gap that acts as the termination of an input tunnel, wherein the input tunnel and the output tunnel act as keyways for the movement of the key, wherein the input tunnel begins with a feeder, while the output tunnel ends with a receiver, wherein the feeder and the receiver constitute flat openings installed on door that enable the insertion and removal, respectively, of the key, wherein the minimum width of the pressure gap represents at least the width of the key.

The semi-spherical decoders are preferably provided on both sides of the key, so that the elastic studs are located additionally on the movable press.

Each of the rings is preferably installed in a separate trough.

Each of the rings is preferably additionally provided with semi-spherical decoding protrusions, while the flat surface of the rotary positioner is additionally provided with semi-spherical recessions, corresponding in shape to the semi-spherical decoding protrusions.

The receiver preferably has the form of a trough.

The movable press and the rotary positioner preferably have the form of a cylinder or a polygon.

The centering through hole preferably has the shape similar to a triangle.

The movable press and the rotary positioner are preferably connected with a handle via the latching/release mechanism.

An embodiment of the invention has been presented in more detail in the enclosed drawings, in which the individual figures present:

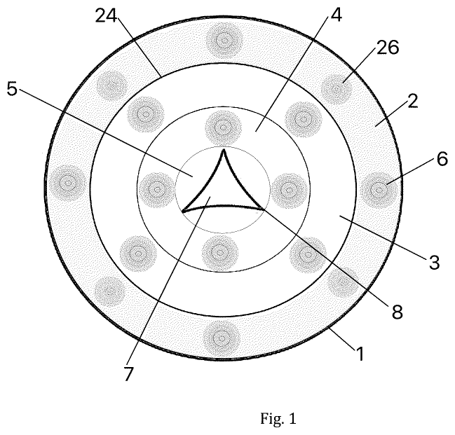

FIG. 1: a front view of the key,

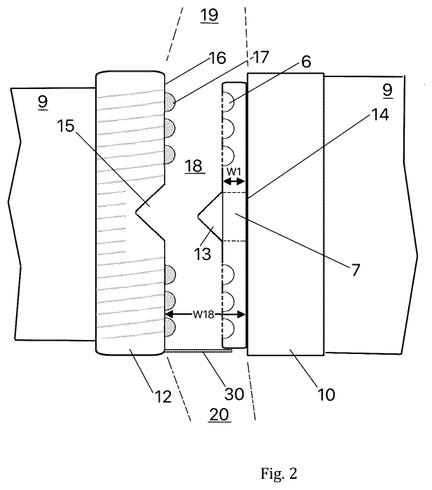

FIG. 2: a side view of the lock with an inserted key,

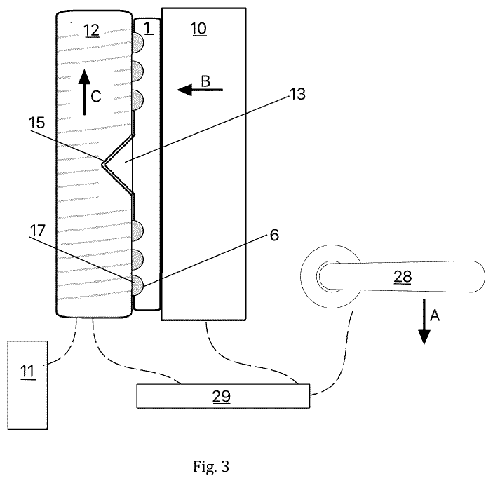

FIG. 3: a side view of the operating process of the lock with key,

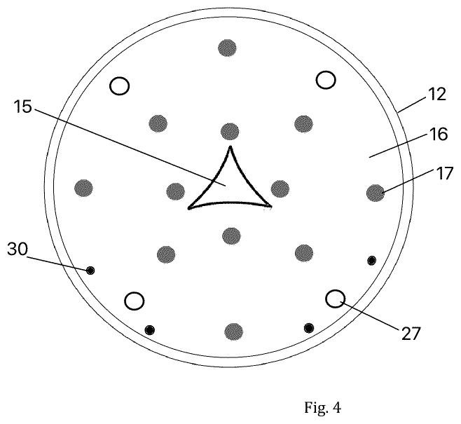

FIG. 4: a front view of the rotary positioner,

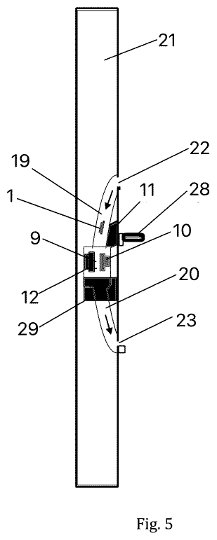

FIG. 5: a cross-section diagram of the device elements.

As shown in FIG. 1, key 1 is provided with a set of three movable, concentrically-arranged, closed rings. Outer ring 2, central ring 3 and inner ring 4 are provided with four semi-spherically shaped decoders 6. Additionally, outer ring 2 has four semi-spherical decoding protrusions 26, which perform the same role as decoders 6. Inner ring 4 is integrated with central disc 5, which has a centrally-located centering through hole 7 having the shape of a triangle with rounded edges, and is provided with three angled corners 8. Outer ring 2, central ring 3 and inner ring 4 are installed in separate troughs 24.

FIG. 2 shows lock 9, which consists of movable press 10 and rotary positioner 12. These elements have the form of a cylinder and are shown in an initial position. Movable press 10 is provided with centrally-provided wedge element 13. Its base 14 has a shape that corresponds to the shape of centering hole 7 of key 1. Rotary positioner 12 is provided with centrally-arranged wedge channel 15 that enables the installation of wedge element 13 therein, at the beginning of the operation of the device. Flat surface 16 of rotary positioner 12 is provided with elastic studs 17 of the shape corresponding to semi-spherical decoders 6 of key 1 and suppressing rods 30, visible in the lower part of flat surface 16. Because of the presence of suppressing rods 30, key 1 stops between movable press 10 and rotary positioner 12. Pressure gap 18 is provided between these elements. It constitutes the ending of input tunnel 19 and the beginning of output tunnel 20. The tunnels have been shown symbolically. Width W18 of pressure gap 18 is larger than width W1 of key 1.

As shown in FIG. 3, key 1 has been inserted and is located between movable press 10 and rotary positioner 12. These elements are connected with handle 28 via latching/release mechanism 29. This connection has been shown symbolically. The movement of handle 28, as indicated by arrow A, has caused latching/release mechanism 29 to displace movable press 10 with key 1 towards rotary positioner 12 and then to rotate rotary positioner 12. The displacement of movable press 10 with key 1 has caused wedge element 13 to settle in wedge channel 15 and the movement of the ends of suppressing rods 30 closer to movable press 10. Meanwhile, as a result of the rotation of rotary positioner 12, its elastic studs 17 have moved across the surface of key 1, before finally settling in its semi-spherical decoders 6. The displacement of rotary press 10 has been indicated with arrow B, while the rotation of rotary positioner 12 with arrow C. As a result of the displacement and rotation, rotary positioner 12 has unlocked the symbolically indicated bolting mechanism 11. In this way, the deadbolt, not visible in the figure, has been displaced and the door can be opened. The locking process is analogous. After the completion of the locking or opening procedure, handle 28 returns to its initial position and latching/release mechanism 29 causes the return of movable press 10 and rotary positioner 12 to the initial position of lock 9, as shown in FIG. 2, as well as the release of key 1 from movable press 10. Upon its release, key 1 moves in the direction of the receiver, which has not been shown in the figure.

FIG. 4 shows rotary positioner 12 with wedge channel 15, as well as the following elements provided on its flat surface 16: twelve elastic studs 17, four suppressing rods 30 and four semi-spherical recesses 27. The visible rotary positioner 12 cooperates with key 1 shown in FIG. 1.

FIG. 5 shows input tunnel 19 and output tunnel 20 which function as keyways for the movement of key 1, both towards and away from lock 9, respectively. The movement path of key 1 has been indicated with an arrow. Input tunnel 19 begins with feeder 22, while output tunnel 20 ends with receiver 23. Feeder 22 and receiver 23 constitute flat openings attached to door 21. Their size and shape are defined by the size and shape of key 1. As a result, it is possible to insert and to retrieve key 1, respectively. Receiver 23 has the shape of a trough. Movable press 10 and rotary positioner 12 are connected with handle 28 via latching/release mechanism 29. Rotary positioner 12 is also connected with bolting mechanism 11.

The set of movable, concentrically-arranged, closed rings used in the key enables the use of a single key for the opening of multiple locks developed in accordance with the invention. This is particularly significant, e.g. in the event of the key being lost. In this case, in order to open a specific door, it is only necessary to configure an appropriate code by moving the rings in the desired direction. The device for opening and locking of a locks described in accordance with the invention therefore represents a certain type of a one-key system.

The number of coding combinations in the device depends on the number of manufactured decoders present in the key and the corresponding number of elastic studs in the lock. Because the key may be provided with decoders on rings on both of its flat sides, and consequently the movable press may be provided with elastic studs, the number of possible coding combinations may be increased. Additionally, the semi-spherical decoding protrusions on the rings and the corresponding semi-spherical recesses on the rotary positioner also improve security.

The door locking device in accordance with the invention responds to the demand for an effective protection of property against unauthorised access. Its design, which does not involve direct access to the lock, practically eliminates the possibility of its opening using a tool such as a picklock that enables the positioning of latches in appropriate positions, or the possibility of breaching the lock by drilling or forcing it.

The shape of the key and tunnels described above and shown in the figures, enables the unobstructed movement of the device towards and away from the lock. Meanwhile, the receiver and feeder, in the form of flat openings, facilitate the process of insertion and removal of the key, respectively. Significantly, the insertion into the device of a different opening device that is incompatible with the lock, or any other object intended to physically block the operation of the mechanism, through the feeder, will result in its ejection through the receiver, and therefore the unobstructed operation of the device.

Even in the event of the insertion of a key in accordance with the invention with rings that do not have the correct combination of the decoders, such a key will be stopped by suppressing rings and, upon the movement of the handle, will be ejected from the lock as an incompatible element.

Because the key in accordance with the invention has three rings, it is possible to memorise the correct code on the basis of a clock dial, where the individual movable rings represent the hours, minutes and seconds, respectively. Another advantage of the key is, in particular, its oval shape, which makes it easier to hold in a pocket and eliminates the risk of the key damaging other objects in a handbag or in a pouch.

The presence of angled corners in the centering through hole allows the key to be securely installed in the base of the wedge element. Whereas the provision of the rotary positioner with a centrally-positioned wedge channel enables the wedge element of the movable press to be securely installed therein.

Additionally, the pressure gap that constitutes the ending of the input channel and the beginning of the output channel is at least as wide as the key, which ensures the positioning of the key between both parts of the lock.

The movable press and the rotary positioner can be generally of any shape, although due to manufacturing reasons they preferable have a cylindrical shape. The key itself can also have the form of a polygon, e.g. a square, in which case the rings are inscribed into its shape.

The described latching/release mechanism, as well as the bolting mechanism, are intended to cooperate with the lock. These elements, despite being a part of the invention, do not define the object of the invention, because other solutions of this type in accordance with the present art can be used for this purpose. Therefore any information about them and their symbolic presentation in the drawings shall be understood as complementary.

The device itself can be used in doors of any type and in other closable barrier systems such as garages, including also following the removal of a lock and the appropriate modification of existing solutions.

The door locking device fully responds to the demand for an effective system for the protection of property stored in confined areas and can be used in entry doors to buildings, residential apartments and hotel rooms, as well as in garage doors, safes, lockers of all kinds, etc.

1. A device for locking doors that restricts the access to confined areas, having a key, lock and a handle, provided with a latching/release mechanism and a bolting mechanism, characterised in that the key (1) has a flat shape and is provided with a set of movable, concentrically-arranged, closed rings in the form of: an outer ring (2), a central ring (3) and an inner ring (4) integrated with a central disc (5), wherein each one of the rings (2, 3, 4) is provided with at least three, semi-spherically shaped decoders (6), while the central disc (5) has a centrally-located stabilising through hole (7) that has at least two angled corners (8), wherein lock (9) consists of a movable press (10) and a rotary positioner (12) connected with the bolting mechanism (11), wherein the movable press (10) is provided with a centrally-located wedge element (13), the base (14) of which has a shape that corresponds to the shape of the stabilising hole (7) of key (1), while the rotary positioner (12) is provided with a centrally-located wedge channel (15) that enables the installation of wedge element (13) of movable press (10) therein, simultaneously the flat surface (16) of the rotary positioner (12) has elastic studs (17), wherein between the movable press (10) and the rotary positioner (12) there is a pressure gap (18) that acts as the termination of input tunnel (20), wherein the input tunnel (19) and the output tunnel (20) act as keyways for the movement of key (1), wherein the input tunnel (19) begins with feeder (22), while the output tunnel (20) ends with receiver (23), wherein the feeder (22) and the receiver (23) constitute flat openings installed on door (21) that enable the insertion and removal, respectively, of key (1), wherein the minimum width (W18) of pressure gap (18) represents at least the width (W1) of key (1).

2. The device according to claim 1, characterised in that semi-spherical decoders (6) are provided on both sides of key (1), and consequently elastic studs (17) are provided additionally on movable press (10).

3. The device according to claim 1, characterised in that each one of the rings (2, 3, 4) is installed in a separate trough (24).

4. The device according to claim 1, characterised in that each of the rings (2, 3, 4) is additionally provided with semi-spherical decoding protrusions (26), while the flat surface (16) of the rotary positioner (12) is additionally provided with semi-spherical recessions (27), corresponding in shape to the semi-spherical decoding protrusions (26).

5. The device according to claim 1, characterised in that the receiver (23) has the form of a trough.

6. The device according to claim 1, characterised in that the movable press (10) and the rotary positioner (12) have the form of a cylinder or a polygon.

7. The device according to claim 1, characterised in that the centering through hole (7) preferably has the shape similar to a triangle.

8. The device according to claim 1, characterised in that the movable press (10) and the rotary positioner (12) are preferably connected with handle (28) via latching/release mechanism (29).
